(19) United States
(12) Patent Application Publication
(10) Pub. No.: US 2026/0174301 A1
(43) Pub. Date: Jun. 25, 2026

(54) MOBILE CLEANING ROBOTS SYSTEMS AND METHODS

(71) Applicant: 1Robert Corporation, Bedford, MA (US)

(72) Inventors: Russell Walter Morin, Burlington, MA (US); Eric J. Burbank, Lynnfield, MA (US); Erik Amaral, Bolton, MA (US); Rogelio Manfred Neumann, Somerville, MA (US); David O. Swett, Bedford, MA (US)

(21) Appl. No.: 19/398,709

(22) Filed: Nov. 24, 2025

Related U.S. Application Data
(63) Continuation of application No. 16/459,309, filed on Jul. 1, 2019, now abandoned.
(60) Provisional application No. 62/691,123, filed on Jun. 28, 2018.

(51) Int. Cl. A47L 11/24; A47L 11/40

(52) U.S. Cl. CPC A47L 11/24; A47L 11/4011; A47L 11/4088; A47L 2201/00; A47L 2201/04

(57) ABSTRACT

A mobile cleaning robot system can include a mobile clearing robot and a vacuum system. The mobile cleaning robot can include a support structure and a drive system operative to move the mobile cleaning robot. The vacuum system can be configured to vacuum a surface.

### CLAIM OF PRIORITY

This patent application is a continuation of U.S. patent application Ser. No. 16/459,309, filed Jun. 27, 2019, which application claims the benefit of priority to U.S. Provisional Application Ser. No. 62/691,123, filed on filed Jun. 28, 2018 (Attorney Docket No. 5329.001PRV), the contents of both which are hereby incorporated by reference herein in their entireties.

### BACKGROUND

Mobile cleaning robots can navigate over a surface such as a floor and clean dirt and debris from the surface. Some mobile cleaning robots, such as the ROOMBATM series robotic vacuum cleaners available from iRobot Corporation, employ air suction to remove direct and debris from a floor surface. See, e.g., the disclosure of U.S. Pat. No. 9,993,129. Some mobile cleaning robots, such as the BRAVATM series robotic mop cleaners available from iRobot Corporation, employ a mopping pad to remove dirt and debris from a floor surface. See, e.g., U.S. Pat. No. 9,907,449.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a top, front perspective view of a mobile cleaning robot system, in accordance with at least one example of this disclosure.

FIG. 2 illustrates a bottom, front perspective view of the mobile cleaning robot of FIG. 1, in accordance with at least one example of this disclosure.

FIG. 3 illustrates a cross-sectional view of the robotic vacuum cleaner of FIG. 2 taken along the line 3-3 of FIG. 1, in accordance with at least one example of this disclosure.

FIG. 4 illustrates a front, top perspective view of the vacuum module forming a part of the robotic vacuum cleaner of FIG. 2, in accordance with at least one example of this disclosure.

FIG. 5 illustrates a rear, top perspective view of the vacuum module of FIG. 4, in accordance with at least one example of this disclosure.

FIG. 6 illustrates a top perspective view of the mobile cleaning robot of FIG. 1, in accordance with at least one example of this disclosure.

FIG. 7 illustrates a top perspective view of the mobile cleaning robot of FIG. 1, in accordance with at least one example of this disclosure.

FIG. 8 illustrates a bottom, front perspective view of the mobile cleaning robot of FIG. 1, in accordance with at least one example of this disclosure.

FIG. 9 illustrates a cross-sectional view of the robotic mop cleaner of FIG. 8 taken along the line 3-3 of FIG. 1, in accordance with at least one example of this disclosure.

FIG. 10 illustrates a front perspective view of the mop module forming a part of the robotic mop cleaner of FIG. 8, in accordance with at least one example of this disclosure.

FIG. 11 illustrates a schematic diagram representing components of the mop module of FIG. 10, in accordance with at least one example of this disclosure.

FIG. 12 illustrates a bottom, front perspective view of a robotic mop cleaner, in accordance with at least one example of this disclosure.

FIG. 13 illustrates a front perspective view of a mop module forming a part of the robotic mop cleaner of FIG. 12, in accordance with at least one example of this disclosure.

FIG. 14 illustrates a schematic view of a mobile cleaning robot according to according to further embodiments, in accordance with at least one example of this disclosure.

FIG. 15 illustrates a bottom view of the mobile cleaning robot of FIG. 15, in accordance with at least one example of this disclosure.

FIG. 16 illustrates a schematic view of a mobile cleaning robot, in accordance with at least one example of this disclosure.

FIG. 17 illustrates a schematic view of a mobile cleaning robot, in accordance with at least one example of this disclosure.

FIG. 18 illustrates a schematic view of a mobile cleaning robot, in accordance with at least one example of this disclosure.

FIG. 19 illustrates a schematic view of a mobile cleaning robot system, in accordance with at least one example of this disclosure.

FIG. 20 illustrates a schematic view of a mobile cleaning robot system, in accordance with at least one example of this disclosure.

FIG. 21 illustrates a schematic view of a mobile cleaning robot, in accordance with at least one example of this disclosure.

FIG. 22 illustrates a schematic view of a mobile cleaning robot, in accordance with at least one example of this disclosure.

FIG. 23 illustrates a schematic block diagram illustrating control systems for a mobile cleaning robot, in accordance with at least one example of this disclosure.

FIG. 24 illustrates a graphical representation of a map of floor types, in accordance with at least one example of this disclosure.

FIGS. 25A-25C are graphical representations of map views illustrating example coverage patterns, in accordance with at least one example of this disclosure.

### DETAILED DESCRIPTION

According to some embodiments, a mobile cleaning robot can navigate around a room or other locations and clean a surface over which it moves. In some implementations, the robot can navigate autonomously, however user interaction may be employed in certain instances. The mobile cleaning robot can operate in each of a vacuuming mode and a mopping mode. In the vacuuming mode, the mobile cleaning robot collects dust and debris from the surface and stores the dust and debris in a bin (e.g., a debris bin) that can be later emptied (e.g., at a later time when the bin is at or near capacity). In the mopping mode, the mobile cleaning robot slides, passes, or drags a mop media (e.g., a pad or web of absorbent material) across and in contact with the surface to remove dirt from the surface and collect the dirt on the mop media.

In some embodiments, a mobile cleaning robot as described can include a modular design wherein one or more modules are selectively installed in and removed from the mobile cleaning robot to configure the mobile cleaning robot for a selected one of the vacuuming mode and the mopping mode.

In some such modular embodiments, a mop module can be provided. When the mop module is installed on the mobile cleaning robot, the mobile cleaning robot is configured in a mopping configuration to operate in the mopping mode. The mop module may replace another functional component of the mobile cleaning robot, such as a vacuum module (e.g., including a debris collection bin).

In some embodiments, a mobile cleaning robot as described can include a hybrid design wherein the mobile cleaning robot can be configured to operate in either a vacuum or a mopping cleaning mode without installation of a mop module or removal of another functional component of the mobile cleaning robot.

The above discussion is intended to provide an overview of subject matter of the present patent application. It is not intended to provide an exclusive or exhaustive explanation of the invention. The description below is included to provide further information about the present patent application.

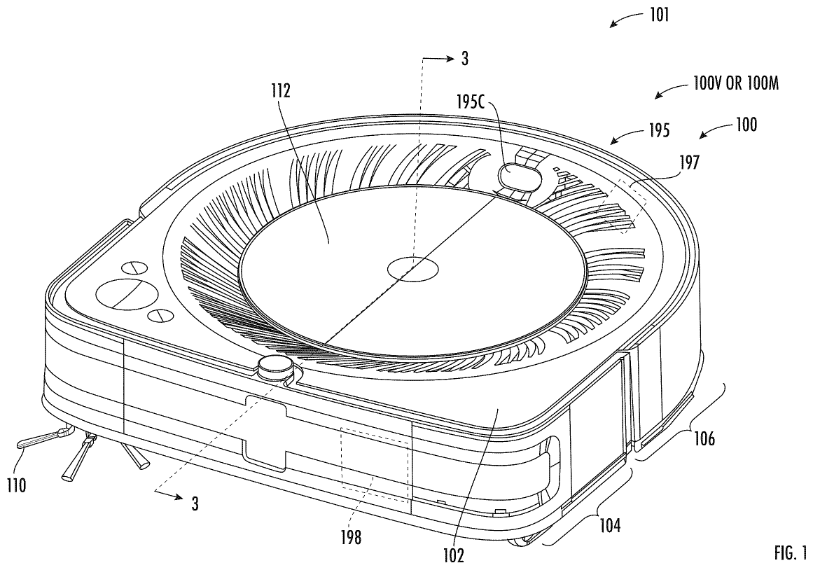

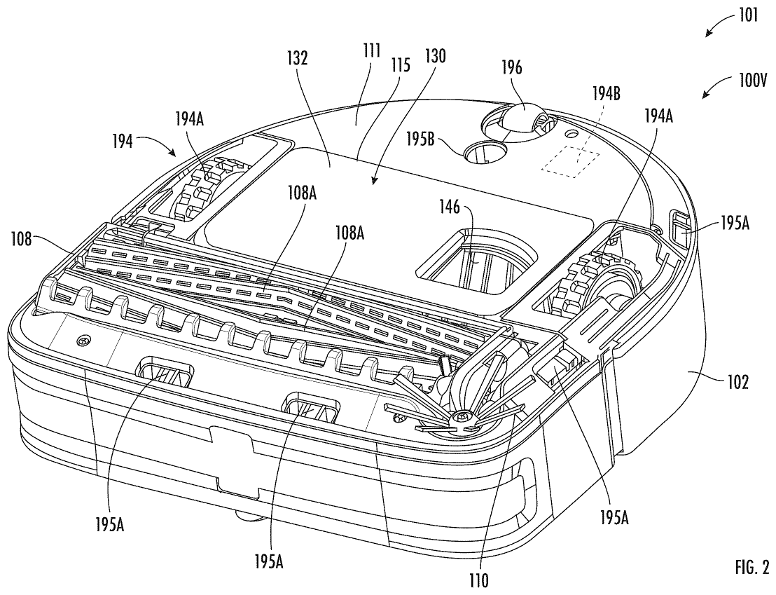

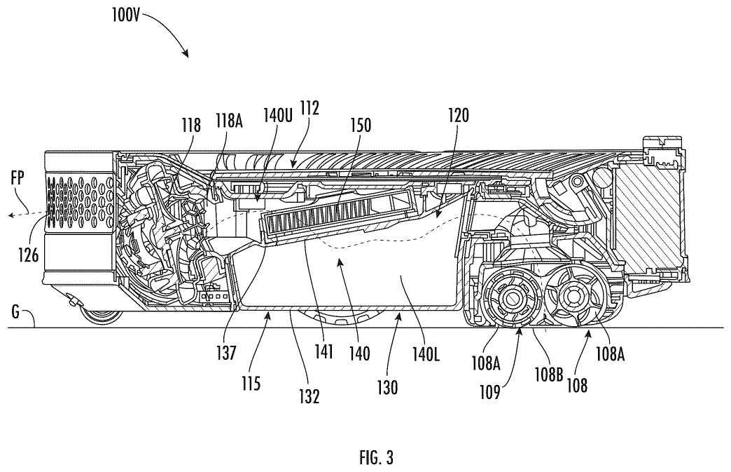

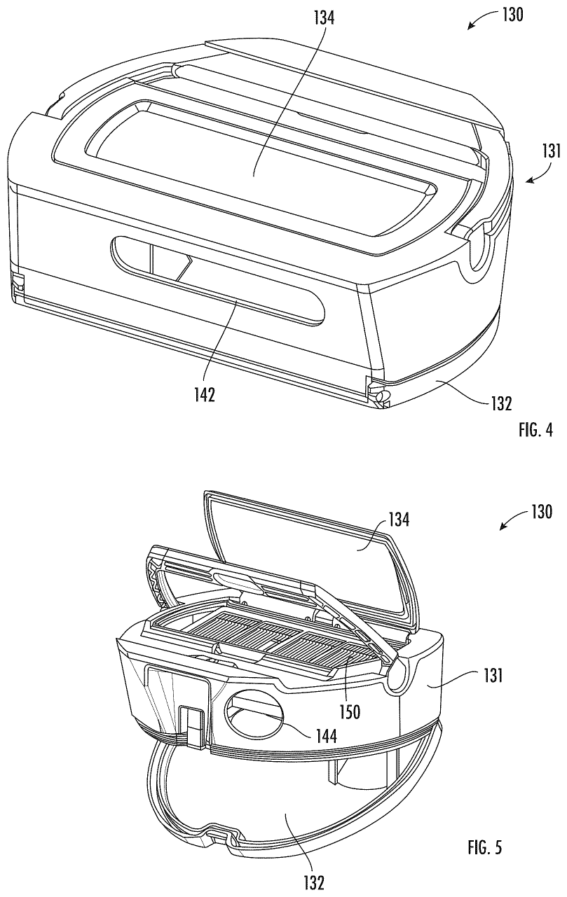

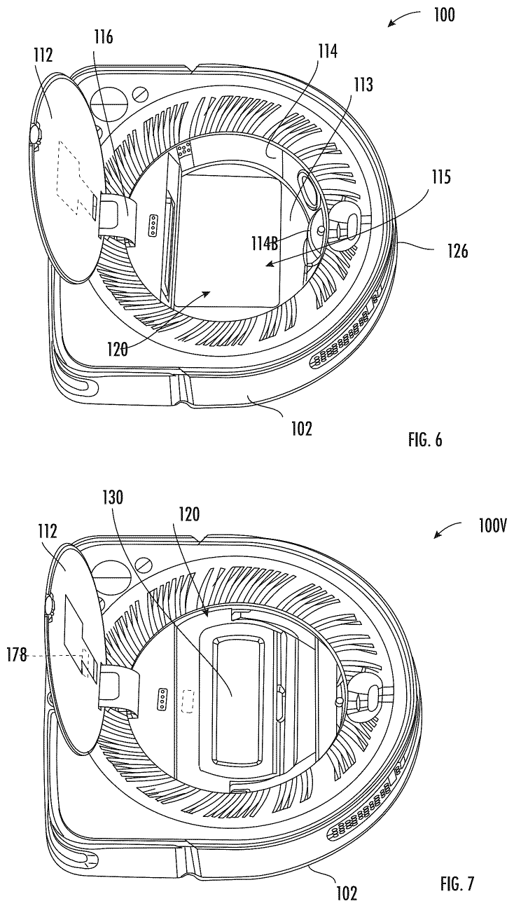

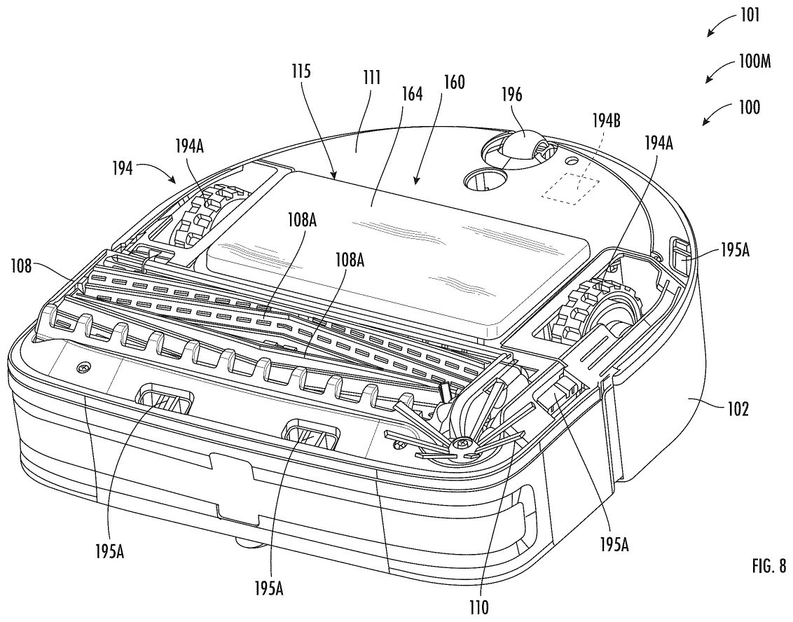

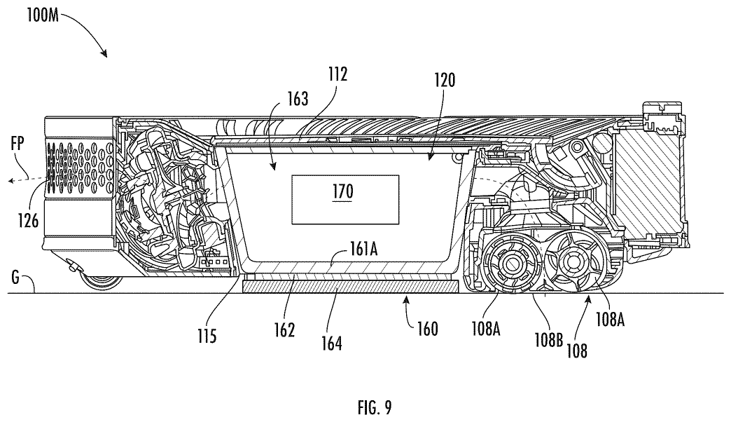

FIGS. 1-11 show an exemplary mobile cleaning robot system 101 of the modular type. The mobile cleaning robot system 101 includes a mobile cleaning robot 100 that can autonomously navigate a cleaning surface and perform cleaning operations on a cleaning surface. The mobile cleaning robot system 101 further includes a dedicated vacuum module 130 and a dedicated mop module 160. The modules 130 and 160 can be interchangeably installed in the robot 100 to enable the robot to execute different corresponding cleaning modes. More particularly, the vacuum module 130 can be installed in the robot 100 to configure the robot 100 as a robotic vacuum cleaner 100V (FIGS. 2 and 3), and the mop module 160 can be installed in the robot 100 to configure the robot 100 as a robotic mop cleaner 100M (FIGS. 8 and 9).

The mobile cleaning robot 100 has a forward portion 104 and an aft portion 106. The mobile cleaning robot 100 includes a blower 118 (e.g., a vacuum source), a cleaning head 108, a motive or drive system 194 for moving the mobile cleaning robot 100, a corner brush 110, a guidance system 195, a rear caster wheel 196, an energy storage battery 197, and an onboard controller 198.

In some implementations of the mobile cleaning robot 100, the forward portion 104 is square cornered with a substantially flat leading edge and the aft portion 106 is a rounded or semi-circular trailing edge, giving the mobile cleaning robot 100 a D-shaped or tombstone-shaped peripheral profile. In other implementations, the mobile robot 100 may have another peripheral profile shape such as a round profile, a triangular profile, an elliptical profile or some non-symmetrical and/or non-geometric shape or industrial design.

The drive system 194 includes left and right drive wheels 194A and one or more motors 194B operable to drive the wheels 194A. The drive wheels 194A may be independent drive wheels that mobilize the robot 100 and provide two points of contact with the floor surface. The drive wheels 194A may be spring loaded. The multi-directional caster wheel 196 provides additional support for the robot 100 as a third point of contact with the floor surface. The electric drive motor or motors 194B are disposed in the housing and operative to independently drive the wheels 194A. The motive components may include any combination of motors, wheels, drive shafts, or tracks as desired, based on cost or intended application of the robot 100.

The guidance system 195 includes cliff detection sensors 195A, a recessed optical mouse sensor 195B aimed at the floor surface for detecting drift, and a camera 195C.

The cleaning head 108 includes cleaning elements or extractors 108A such as rotatable rollers mounted at a suction opening 108B in the underside of the robot 100. The cleaning head 108 may further include a motor operable to forcibly rotate the extractors 108A. The extractors 108A may be brush rollers and/or pliable rubber rollers, for example. The cleaning head 108 and the extractors 108A are seated in an exterior or cleaning head socket or cavity 109.

The blower 118 may be an electrical impeller fan or other vacuum source for generating airflow within the mobile cleaning robot 100.

The controller 198 (e.g., a microprocessor-based controller and associated memory) may control the drive motor 194C, the cleaning head 108, and the blower 118 using data input from the sensors 195A-C and/or other data.

The drive motor 194C, the guidance system 195 and the blower 118 may be powered by the onboard battery 197.

The mobile cleaning robot 100 includes a rigid support structure 102. The support structure 102 forms a structure that supports the blower 118, the battery 197, and the cleaning head 108, and when installed, the vacuum module 130 or the mop module 160. The support structure 102 may include a unitary or non-unitary frame, chassis, body, or assembly, for example.

The support structure 102 also forms a bin receiving compartment, well or seating 120 for receiving or otherwise supporting the module 130 or the module 160. The modules 130, 160 can be alternatively inserted into and removed from the seating 120 selectively for servicing and changing the cleaning mode configuration of the robot 100.

When installed or received in the mobile cleaning robot 100, the module 130 can serve as a debris bin to collect and store debris collected from the surface being cleaned.

The seating 120 includes one or more sidewalls 114 and a floor 113 that form a cavity in the support structure 102 for receiving the modules 130, 160. The lower boundary of the seating 120 is defined by the floor 113 on which the installed module 130, 160 rests when the module 130, 160 is inserted into the seating 120. A bottom opening 115 is defined in the bottom wall 113.

The mobile cleaning robot 100 includes an access lid or panel 112 that covers the seating 120. The access panel 112 encloses the installed module 130, 160 within the mobile cleaning robot 100 and prevents the installed module 130, 160 from being removed during a cleaning mission. The access panel 112 is affixed to the support structure 102 by a panel hinge 116 such that the bin access panel 112 can be selectively rotated open and closed over the seating 120.

The vacuum module 130 includes a housing 131 and a filter 150. The housing 131 has a lid 134 and a bottom wall 132. The housing 131 includes an internal containment volume or chamber 140 in fluid communication with-an intake port 142 and an exhaust port 144. An internal barrier 137 is disposed in the chamber 140. When the bin 130 is seated in the seating 120, the exhaust port 144 aligns with an intake duct 118A of the blower 118. In some implementations, an exhaust port seal (e.g., a pliable lip) is provided around the exhaust port 144 and forms a seal with the surface about the blower intake duct 118A.

The internal barrier 137 defines a filter flow through aperture 141 and separates or partitions the chamber 140 into a lower or first internal containment subchamber or volume 140L and an upper or second internal containment subchamber or volume 140U on either side of the internal barrier 137. The first volume 140L is fluidly connected to the second volume 140U by the filter flow through aperture 141. In use, the filter unit 150 is installed over the aperture 141.

During cleaning operations, the first volume 140L receives dust-laden air and debris from the cleaning head 108 though the intake port 142 and expels air through the filter unit 150. During operation, the second volume 140U receives filtered air from the first volume 140L through the filter unit 150 and expels air through the exhaust port 144. The blower 118 sucks in cleaned air through the exhaust port 144 and expels the air from the mobile cleaning robot 100, through a vent 126 in the aft portion 106. The first volume 140L stores the debris collected by the cleaning head 108, such as dust or debris lifted from a cleaning surface on which the mobile cleaning robot 100 travels. The housing 131 has a bottom wall 132. The bottom wall 132 may be a hinged door that can be opened to empty dirt from the subchamber 140L.

In some implementations, the vacuum module 130 includes an evacuation port 146. The evacuation port 146 is an additional port in the bottom wall that remains closed during some operations, such as cleaning operations, but can open for other operations, such as bin 130 evacuation operations.

Evacuation can occur autonomously from an external evacuation station. When the mobile cleaning robot 100 determines that evacuation of the module 130 is needed (e.g., the module 130 is full or at the request of a remote application such as a mobile device application), the mobile cleaning robot 100 navigates to the evacuation station. The evacuation station can be integrated with a docking station (e.g., a charging dock). For example, evacuation can occur during a recharge of a power system of mobile cleaning robot 100. When the mobile cleaning robot 100 navigates to the external evacuation station, the evacuation port 146 aligns with a suction mechanism of the external evacuation station, and the debris inside the module 130 is sucked from the module 130 through the evacuation port 146. In some embodiments, a user possesses a remote computing device (e.g., a mobile phone or other mobile device) that includes a robot control application and is networked to the robot 100. The robot control application enables the user to monitor the fullness state of the debris module 130 via the mobile device (e.g., by sending a request to and/or receiving an unsolicited notification from the robot 100). The user can then use the robot control application to send the robot 100 a command to empty the module 130, responsive to which the mobile cleaning robot 100 will navigate to the evacuation station.

The evacuation port 146 may include a valve or movable flap or barrier that moves between an open position and a closed position. The movable barrier selectively seals and opens enabling evacuation of the contents of the module 130. In the closed position, the flap blocks air flow between the module 130 and the environment. In the open position, a path is formed in the open passage through the flap between the module 130 and the evacuation port 146. The movable barrier may open in response to a difference in air pressure at the evacuation port 146 and within the module 130. The evacuation station can generate a negative air pressure (e.g., a suction force) that causes the flap to open and sucks the debris out of the module 130 and to the evacuation station. The evacuation of the module 130 by the evacuation station can occur autonomously without the module 130 being removed from the mobile cleaning robot 100. The module 130 may include a biasing mechanism (e.g., a torsion spring) that biases the movable barrier into the closed position.

The filter 150 may include filter media formed of any suitable material. In some implementations, the filter media includes a fibrous material that allows air to pass through the material but traps dust, debris, etc. The filter media may include folds that increase the surface area of the filter material exposed to the airflow path.

The mop module 160 includes a housing 161, a mop media holder (“pad holder”) 162, and a mop media (“cleaning pad”) 164. The housing 161 includes an internal chamber 163. The pad holder 164 forms a part of or is mounted on a bottom wall 161A of the housing 161.

The cleaning pad 164 is mounted on and secured to the housing 161 by the pad holder 162. The pad holder 162 and/or pad 164 may include any suitable pad retention mechanisms such as clips, brackets, clamps, snaps, adhesive, or hook and loop fasteners. The pad holder 162 may also include a pad release mechanism operable to release or eject the pad 164 from the pad holder 162 for replacement. The pad holder 162 and the pad 164 collectively form a mop end effector.

When the mop module 160 is seated in the seating 120, a lower portion of the module 160 extends through the bottom opening 115 and the cleaning pad 164 is positioned at the underside of the robot 100. More particularly, the cleaning pad 164 is positioned such that a contact face 164A of the cleaning pad 164 engages the surface G to be cleaned when the robot 100 (configured as a mopping robot) is placed on the surface G with the wheels 194A down as shown in FIG. 9.

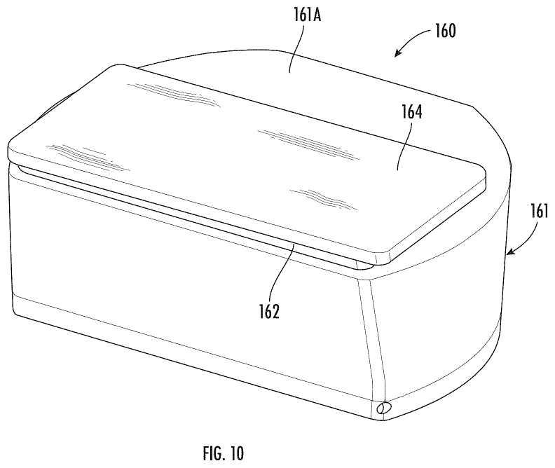

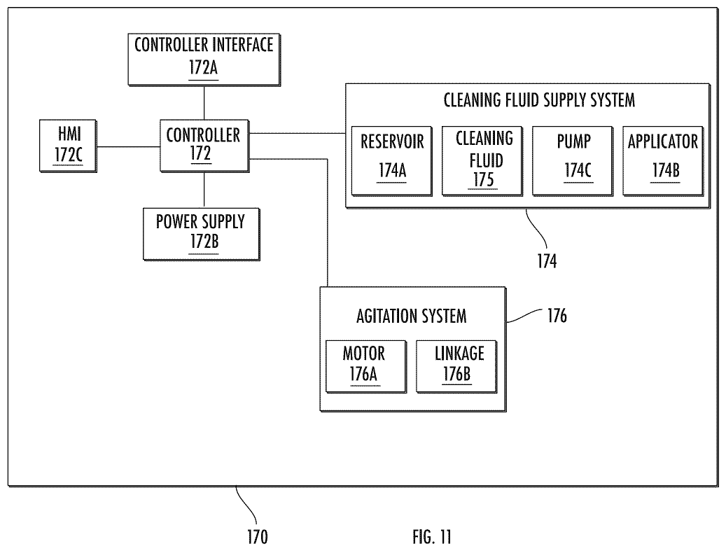

Optionally and with reference to FIGS. 10 and 11, the mop module 160 may include one or more additional functional components (designated generally 170 in FIG. 10) in or on the housing 161, or positioned elsewhere on the robot 100.

In some embodiments, the mop module 160 includes an onboard controller 172. The onboard controller 172 may communicate with the robot controller 198 via a controller interface 172A. For example, the module 160 and the robot 100 may include cooperating electrical connectors that engage one another when the module 160 is properly seated in the seating 120.

In some embodiments, the mop module 160 includes a cleaning fluid supply system 174. The cleaning fluid supply system 174 is operative to apply a cleaning fluid 175 to the surface G to assist in removing dirt from the surface G. The system 174 may include a reservoir 174A containing a supply of the cleaning fluid 175, a cleaning fluid applicator 174B to deliver or dispense the cleaning fluid from the reservoir 174A, and a pump 174C to deliver the cleaning fluid from the reservoir 174A to the applicator 174B.

In some embodiments, the cleaning fluid applicator 174B includes one or more nozzles or ports from which the cleaning fluid 175 is sprayed, dripped or otherwise dispensed directly onto the surface G.

In some embodiments, the cleaning fluid applicator 174B includes one or more nozzles or ports from which the cleaning fluid 175 is sprayed, dripped or otherwise dispensed onto or into the cleaning pad 164, and the dispensed cleaning fluid is thereafter transferred from the cleaning pad 164 to the surface G.

In some embodiments, the mop module 160 includes an agitation system 176. The agitation system 176 is operative to forcibly move the cleaning pad 164 (relative to the robot chassis) to create a scrubbing action between the pad 164 and the surface G. The agitation movement may be fore and aft, left and right, up and down, oscillating, or a combination thereof. The agitation system 176 may include an agitation motor 176A and a linkage 176B to transfer the force of the motor 176A to the pad holder 162.

In some embodiments, the pump 174 and/or the agitation motor 176A is electrically powered by the battery 197 of the robot 100.

In some embodiments, the pump 174C and/or the agitation motor 176A is mechanically powered via the drive system 194 of the robot 100.

In some embodiments, the pump 174C and/or the agitation motor 176A is pneumatically powered by the blower 118 of the robot 100.

In some embodiments, the mop module 160 includes an onboard power supply 172B such as a battery to power components of the module 160 (e.g., the fluid pump 174C and/or the agitation motor 176A).

The mop module 160 may include an onboard human machine interface (HMI) 172C. The HMI 172C may include a display and/or control elements enabling a user to monitor and/or a statuses or systems of the module 160. For example, the HMI 172C may indicate a fill status of the reservoir 174A, a charge level of the battery 172B, or settings of the cleaning fluid supply system 174 and agitation system 176.

The mobile cleaning robot 100 may be used as follows to execute cleaning of a surface. The operation of the robot 100 will first be described for use as a robotic vacuum cleaner. However, it will be appreciated that the order of use may be reversed as desired.

In some implementations, a module presence sensor 178 is mounted on the robot 100 (e.g., in the module access door 112) with a cooperating feature or component being mounted in or on each of the vacuum module 130 and the mop module 160. A signal from the module presence sensor 178 can be used by a controller (e.g., the onboard controller 198) to determine (in some embodiments, automatically and programmatically) whether and which of the modules 130, 160 is present inside the mobile cleaning robot 100. The controller 198 may then automatically and programmatically operate the robot 100 in accordance with the configuration of the robot 100 (i.e., as a robotic vacuum cleaner or a mopping robot).

If neither module 130, 160 is present in the seating 120 or the module is not properly positioned during the cleaning operation, the controller 198 of the mobile cleaning robot 100 will prevent the mobile cleaning robot 100 from operating at least certain subsystems or functions. The controller 198 may actuate or send a signal or alert to the user indicating that there is an error associated with the modules 130, 160.

The vacuum module 130 is installed in the seating 120 as shown in FIGS. 2, 3 and 7. FIG. 3 is a schematic side view cutaway of the mobile cleaning robot 100 showing placement of the module 130 within the mobile robot 100 and the path of an airflow FP through the mobile robot 100 as indicated by a dashed line.

The robot 100 then traverses the surface G to be cleaned while operating the blower 118 and extractor motor. The extractors 108A and blower 118 vacuum cooperate to lift and remove dirt (e.g., loose particles and debris) from the surface G into the robot 100 through the opening 108B.

During operation, the module 130 is disposed in the airflow path FP and the blower 118 pulls air through the module 130. The blower 118 pulls air through the cleaning head 108 and the module 130 to create a negative pressure (e.g., vacuum pressure effect) on a cleaning surface that is proximate to the cleaning head 108. In some implementations, the airflow FP is a pneumatic airflow. The air of the airflow FP carries debris and dirt into the module 130 from the cleaning surface. The air is cleaned by the filter unit 150 disposed in the module 130, through which the airflow path FP proceeds during operation of the mobile cleaning robot 100.

Clean air is expelled through the vent 126. Debris carried by the airflow FP is separated from the air flow by the filter and deposited in the volume 140L of the module 130. The module 130 is removable from the mobile cleaning robot 100, for example, to be emptied of debris by a user, cleaned, and/or replaced with the mop module 160.

The mop module 160 is then installed in the seating 120 as shown in FIGS. 8 and 9. A signal from the module presence sender 178 can again be used to determine that the mop module 160 is installed in the robot 100. FIG. 9 is a schematic side view cutaway of the mobile cleaning robot 100 showing placement of the module 160 within the mobile robot 100.

The robot 100 then traverses the surface G to be cleaned. The cleaning pad 164 engages and slides along and in intimate contact with the surface G, and thereby removes dirt from the surface G onto (which may include into) the cleaning pad 164.

In some embodiments, the cleaning pad 164 also absorbs cleaning fluid from the surface G. In some embodiments, the cleaning fluid supply system 174 dispenses the cleaning fluid 175 onto the surface G, and the dispensed cleaning fluid is absorbed by the cleaning pad 164 as it passes over the surface G.

In some embodiments, the agitation system 176 displaces (agitates) the cleaning pad 164 as it passes over the surface G to scrub the surface.

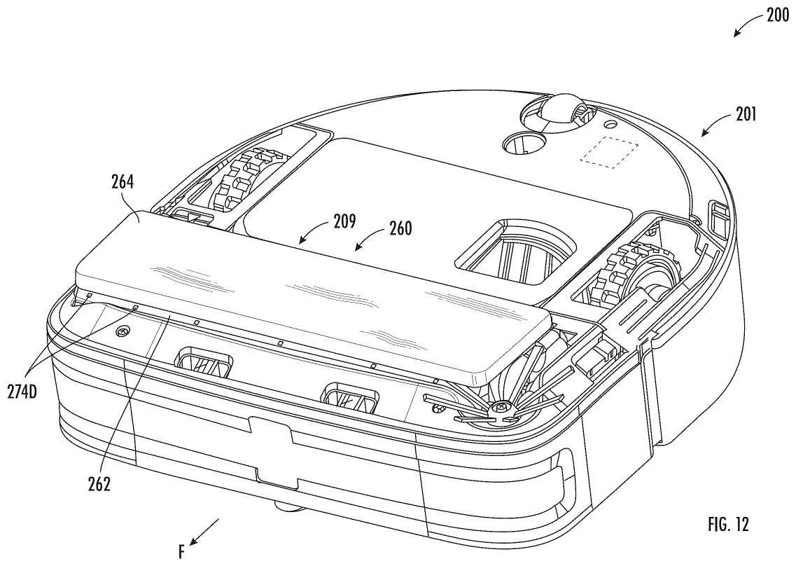

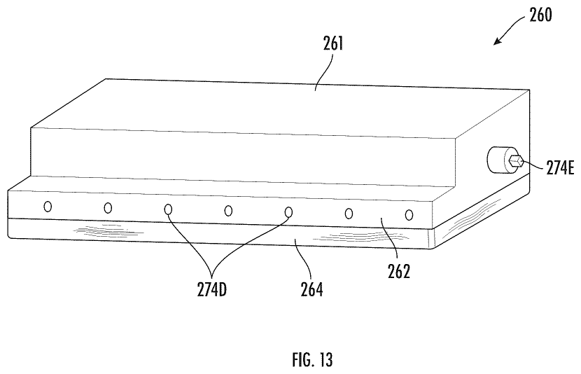

With reference to FIGS. 12 and 13, a mobile cleaning robot system 201 according to further embodiments is shown therein. The mobile cleaning robot system 201 includes a mobile cleaning robot 200 generally corresponding to the mobile cleaning robot 100, and a mop module 260. The mobile cleaning robot system 201 is also of the modular type and differs from the mobile cleaning robot system 101 in that the mop module 260 is interchangeable with extractors corresponding to the extractors 108A rather than a vacuum module corresponding to the vacuum module 130.

An exemplary mop module 260 as shown in FIG. 13 is provided with a housing 261 configured to be mounted in the extractor cavity 209 of the robot 200 when the extractors are removed therefrom. In some examples, the mop module 260 can be user-installable in the extractor cavity 209 when the extractors are removed therefrom. In other examples, the mop module 260 can be installed by a robot cleaning system, such as the robot cleaning system 701 discussed below. In both examples, the mop module 260 can be releasably installable within the extractor cavity 209. For example, when the mop module 260 needs replacement, service (a new pad or mop media), or it is desired to use the extractors, the mop module 260 can be removed by the user or the robot cleaning system 701.

The mop module 260 further includes a pad holder 262 and a cleaning pad (or “mop media”) 264 corresponding to the components 162 and 164. The cleaning pad 264 is mounted on and secured to the housing 261 by the pad holder 262. The pad holder 262 and/or pad 264 may include any suitable pad retention mechanisms and also a pad release mechanism as discussed above.

The housing 261 includes an internal chamber. The mop module 260 may further include components corresponding to one or more of the components 170 discussed above in the chamber. In particular, in some embodiments the mop module 260 includes a cleaning fluid supply system 274 corresponding to the cleaning fluid supply system 174. The cleaning fluid supply system 274 includes spray ports or nozzles 274D that are directed forwardly of the cleaning pad 264 when the mop module 260 is installed. In some embodiments, the system 274 sprays the cleaning fluid onto the surface G a prescribed distance in front of the pad 264 when the robot 200 is travelling in a forward direction F to enable time for the cleaning surface to soak prior to removal or scrubbing by the pad 264.

As discussed above, a cleaning fluid supply system and/or agitation system of the mop module 260 can be powered by a battery onboard the module 260, a battery of the robot 200, a blower of the robot 200, or a drive motor of the robot 200. In some embodiments, the module 260 includes a drive mechanism (e.g., a drive shaft 274E) that engages an extractor drive gear of the robot 200 to directly drive a cleaning fluid supply system and/or agitation system of the module 260.

It will be appreciated that because the mop module 260 is not interchangeable with a vacuum module, the components of the vacuum module 130 can be permanently affixed to the robot 200.

In alternative embodiments, the mop module 260 is configured to be mounted in the cavity of the robot 200 that holds a cleaning head corresponding to the cleaning head 108. In this case, in order to convert the robot 200 from the vacuum mode to the mopping mode, the cleaning head is removed from the robot 200 and the mop module 260 is mounted in its place.

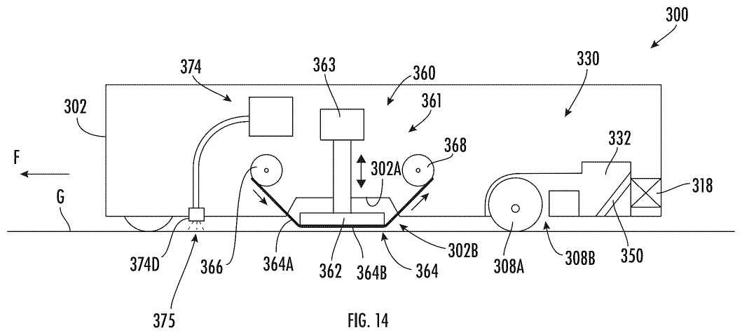

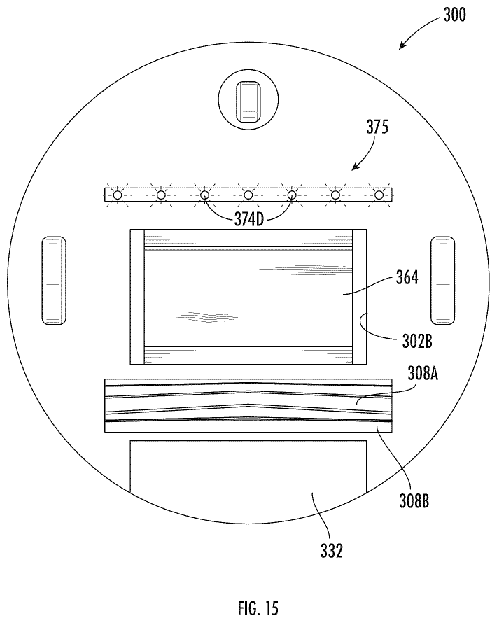

With reference to FIGS. 14 and 15, a mobile cleaning robot 300 according to further embodiments is shown schematically therein. The mobile cleaning robot 300 may generally correspond to the mobile cleaning robot 100 with the vacuum module 130 installed, except as follows. As illustrated, the robot 300 includes an integral vacuum cleaning system 330 including an extractor 308A, a suction opening 308B, a debris bin 332, a filter 350, and a blower 318 corresponding to the components 108A, 108B, 140L, 150 and 118. The mobile cleaning robot 300 may be of the hybrid type.

The robot 300 further includes a mop system 360. The mop system 360 includes a mop media supply system 361 and, optionally, a cleaning fluid supply system 374.

The mop media supply system 361 includes a head or mop media support (“web support”) 362, a deployment actuator 363, a web supply roll 366, a web take up roll 368, and a web of mop media 364.

The mop media web 364 is mounted on and extends continuously between the rolls 366, 368 such that clean web 364A can be paid out from the supply roll 366, drawn under the web support 362, and collected on the take up roll 368.

The web support 362 may be a rigid plate, for example.

The actuator 363 may be a solenoid, for example.

In use, the actuator 363 forcibly displaces or pushes the web support 362 down toward the surface to be cleaned so that a section 364B of the web 364 between the web support 362 and the surface G engages the surface G to effect mop cleaning of the surface G. The web 364 is drawn from the roller 366 to the roller 368 to position a new (clean) section of the web under the web support 362. In this manner, the dirtied web section 364B is replaced with a new clean section for continued cleaning of the surface G.

In some embodiments, the system 361 raises the web support 362 when the robot 300 is not in mopping mode (e.g., the robot 300 is in vacuuming mode) so that the web 364 is positioned out of contact with the surface G. In some embodiments, the web section 364B is retracted into a cavity 302A of the robot housing 302 through an opening 302B in the underside, undercarriage or bottom wall of the robot 300 into a retracted or stored position. When the robot 300 enters mopping mode, the system 361 operates the actuator 363 to drive the web support 362 down into a cleaning or deployed position (as shown in FIG. 14), wherein the web section 364B contacts the surface G to be cleaned.

The web 364 may be advanced from the roller 366 to the roller 368 using any suitable mechanism. In some embodiments, the take up roller 368 is powered. In some embodiments, one or both of the rollers 366, 368 is provided with a ratcheting mechanism that causes the web to advance from the roller 366 to the roller 368 each time the web holder 362 pushes the web 364 down and releases the web 364 up.

The cleaning fluid supply system 374 may operate as described above for the cleaning fluid supply system 174. As illustrated, the cleaning fluid supply system 374 includes a nozzle or nozzles 374D that dispense (e.g., spray) cleaning fluid 375 onto the surface forwardly of the advancing web section 364B as the robot 300 travels in a forward direction F.

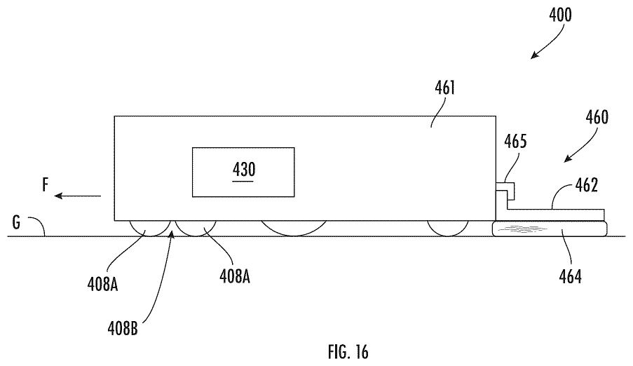

With reference to FIG. 16, a mobile cleaning robot 400 according to further embodiments is shown therein. The mobile cleaning robot 400 includes an integral vacuum cleaning system 430 corresponding to the integral vacuum cleaning system 330 and including extractors 408A, a suction opening 408B, a debris bin (not shown), filter (not shown), and blower (not shown). The mobile cleaning robot 400 may be of the hybrid type. The robot 400 may be generally constructed and operated in the manner described for the robot 300, but differs from the robot 300 in that the mop system 360 is replaced with a mop system 460.

The mop system 460 includes a mop media holder 462 (e.g., cleaning pad holder) attached to and extending from the rear end 400B of the robot 400. A mop media (e.g., cleaning pad) 464 is secured to the holder 462 such that the cleaning pad 464 is maintained in contact with the surface G to be cleaned by the cleaning pad 464 as the robot 400 traverses the surface G (e.g., in a forward direction F). The robot 400 may include a mounting device 465 to releasably secure the pad holder 462 to the robot 400. The mop media holder 462 thus positions the cleaning pad 469 laterally outward or outbound from the robot beyond the perimeter of the body 403 of the robot 400.

In some examples, the holder 462 and/or the cleaning pad 464 can be user-installable. In other examples, the holder 462 and/or the cleaning pad 464 can be installed by a robot cleaning system, such as the robot cleaning system 701 discussed below. In both examples, the holder 462 and/or the cleaning pad 464 can be releasably installable to a housing 461 of the mobile cleaning robot 400. For example, when the holder 462 and/or the cleaning pad 464 need replacement, service (a new pad or mop media) the holder 462 and/or the cleaning pad 464 can be removed by the user or the robot cleaning system 701.

With reference to FIG. 17, a mobile cleaning robot 500 according to further embodiments is shown therein. The robot 500 may be generally constructed and operated in the manner described for the robot 400, but differs from the robot 400 in that the mop media holder 562 (e.g., cleaning pad holder) of the robot 500 is coupled to the body at an external surface 563 of the robot 500 by a hinge 566. The hinge 566 enables the operator to pivot the cleaning pad 564 into each of a stored or retracted position (shown in solid lines; wherein the pad 564 is retained out of contact with the surface G) and a deployed or extended position (shown in dashed lines; wherein the pad 564 is retained in contact with the surface G to effect cleaning of the surface G).

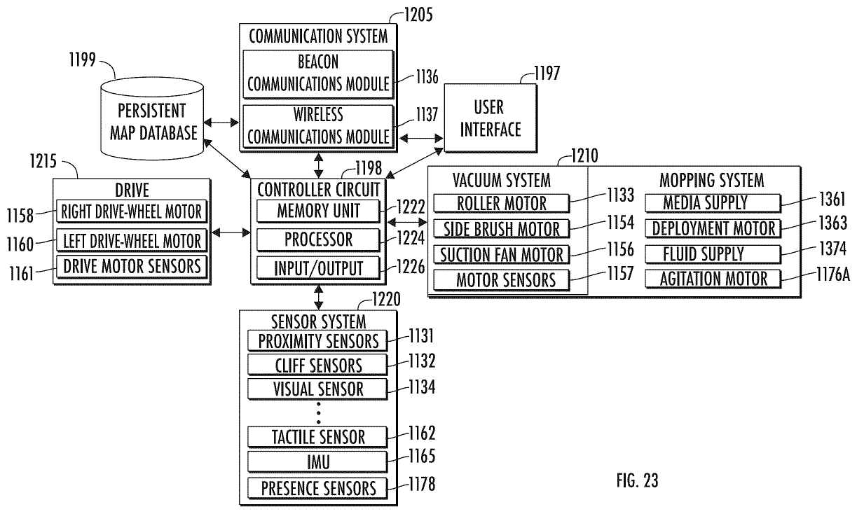

In some examples, the mobile cleaning robot 500 can include a mechanism or actuator 568 that can be connected to a housing 561 of the mobile cleaning robot 500. The actuator 561 can be any type of motor such as an electrically powered servo, electric motor, solenoid, stepper motor, or the like. The actuator 561 can be connected to a controller, such as the controller 172. The actuator 561 can be further connected to the mop media holder 562 to move the mop media to pivot the cleaning pad 564 into each of a stored or retracted position. In some examples, the controller 172 can be configured to receive a user indication flooring type in an environment via a user interface, such as the HMI 172C. The controller 172 can be further configured to detect a detected flooring type in the environment based on output from one or more sensors connected to the robot housing, such as any of the sensors of the sensor system 1220 of FIG. 23 (discussed below).

The controller 172 can further be configured to operate the actuator 568 to move the cleaning pad holder 562 between the stored position and the deployed position based on the user indication flooring type or the detected flooring type. In some examples, the controller 172 can be configured to correlate the user indication flooring types with the detected flooring type based on the output from the one or more sensors to produce a correlated flooring type.

In further examples, the controller 172 can be configured to operate the actuator 568 to move the cleaning pad holder 562 to the stored position when the mobile robot 500 approaches a correlated flooring type of a carpet, and is configured to move the cleaning pad holder 562 to the deployed position when mobile robot 500 encounters a correlated flooring type of a hard floor.

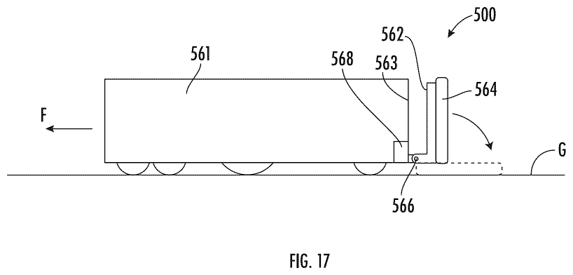

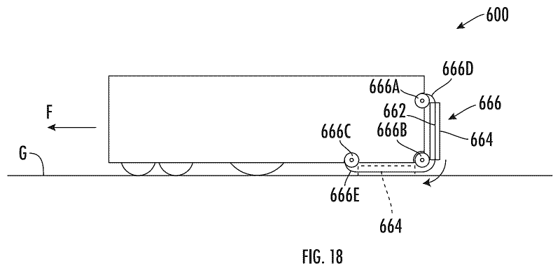

With reference to FIG. 18, a mobile cleaning robot 600 according to further embodiments is shown therein. The robot 600 may be generally constructed and operated in the manner described for the robot 400, but differs from the robot 400 in that the mop media holder 662 (e.g., cleaning pad holder) of the robot 600 is coupled to the body of the robot 600 by a positioning system 666. In the illustrated embodiment, the positioning system 666 includes rollers 666A, 666B, 666C and cables 666D, 666E coupling the mop media (e.g., cleaning pad or web) 664 to the body of the robot 600.

The positioning system 666 can be operated to translate the cleaning pad 664 into each of a stored or retracted position (shown in solid lines; wherein the pad 664 is retained out of contact with the surface G) and a deployed or extended position (shown in dashed lines; wherein the pad 664 is retained in contact with the surface G to effect cleaning of the surface G). For example, the pad 664 may be manually translated into the respective positions by rotating the roller 666A or the roller 666C.

In some embodiments, the mop media 664 is a mop media web that is paid out from one roller (e.g., the roller 666A) and taken up on another roller (e.g., the roller 666C) as described above for the mop system 360 of the robot 300.

It may be necessary of desirable to replace a mop media (e.g., cleaning pad or web) from time to time with a new, clean mop media. In some embodiments, an operator can manually remove a mop media from the mop media holder and/or can manually install a new mop media on the mop media holder. Alternatively, the robot or a system including the robot may be provided with an automated mechanism or mechanisms to remove and/or install the mop media. In some embodiments, a mechanism is provided onboard the robot to automatically remove a mop media from the mop media holder. In some embodiments, a mechanism is provided onboard the robot to automatically install a new mop media on the mop media holder. In some embodiments, a mechanism is provided on a dock to automatically remove a mop media from the mop media holder. In some embodiments, a mechanism is provided on a dock to automatically install a new mop media on the mop media holder.

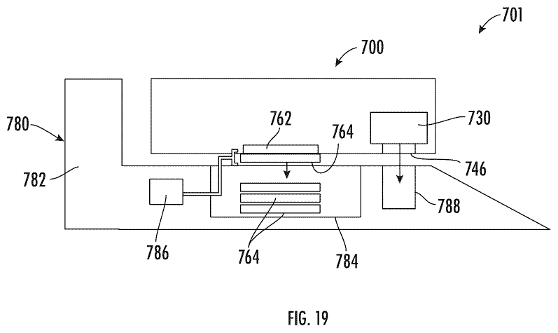

With reference to FIG. 19, a mobile cleaning robot system 701 according to further embodiments is shown therein. The mobile cleaning robot system 701 includes a mobile cleaning robot 700 and a dock 780.

The mobile cleaning robot 700 may include a vacuum system and a mopping system as described herein, for example. As schematically illustrated, the robot 700 includes a mop media holder (e.g., cleaning pad holder 762), a mop media (e.g., cleaning pad or web) 764 affixed to the holder 762, a vacuum debris bin 730, and a debris evacuation port 746 corresponding to the components 162, 164, 130, and 146 of the mobile cleaning robot 100, for example.

The dock 780 includes a housing 782, a mop media storage compartment 784, a mop media removal system 786, and a debris evacuation system 788. The dock 780 may further include an electrical power charger and electrical contacts to charge a battery of the robot 700.

In use, the robot 700 travels onto the dock 780. For example, the robot 700 may execute a mopping operation, thereby dirtying the mop media 764, and then travel onto the dock 780. The mop media removal system 786 then automatically and programmatically removes the mop media 764 from the holder 762 and discards the removed mop media 764 in the mop media storage compartment 784.

Once the mop media 764 has been removed, the robot 700 can leave the dock 780 and execute a vacuum cleaning operation or a new mop media 764 can be mounted on the robot 700 and the robot 700 can again execute a mopping operation. In some embodiments, the robot 700 may include an onboard supply of one or more additional mop medias 764 (as discussed below with regard to the robot 900) and can execute a further mopping operation without being reloaded.

With reference to FIG. 20, a mobile cleaning robot system 801 according to further embodiments is shown therein. The mobile cleaning robot system 801 includes a mobile cleaning robot 800 and a dock 880.

The mobile cleaning robot 800 may include a vacuum system and a mopping system as described herein, for example. As schematically illustrated, the robot 800 includes a mop media holder (e.g., cleaning pad holder) 862 and a mop media (e.g., cleaning pad or web) 864 affixed to the holder 862.

The dock 880 includes a housing 882, a mop media storage compartment 884, a supply 864A of mop media 864 disposed in the compartment 884, and a mop media loading system 886. The dock 880 may further include an electrical power charger and/or a debris evacuation system as described above. The mop media supply 864A may be provided in the form of a cartridge or package of mop medias 864.

In use, the robot 800 travels onto the dock 880. The mop media loading system 886 then automatically and programmatically removes a mop media 864 from the mop media storage compartment 884 and installs the mop media 864 on the mop media holder 862.

Once the mop media 864 has been installed on the holder 862, the robot 800 can leave the dock 880 and execute a mopping operation. In some embodiments, the robot 800 may include an onboard mop media ejector (as discussed below with regard to the robot 900) and can discard the mop media 864 after use and return to the dock 880 for automatic loading of a new mop media on its holder 864.

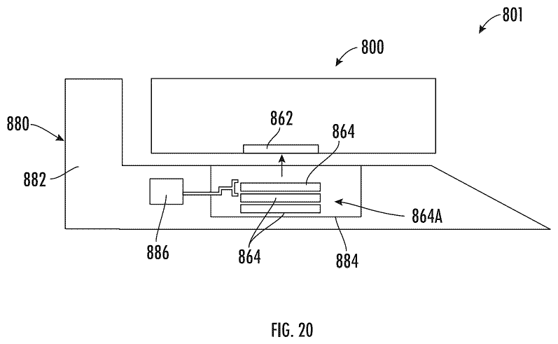

With reference to FIG. 21, a mobile cleaning robot 900 according to further embodiments is shown therein. The mobile cleaning robot 900 may include vacuum system and a mopping system as described herein, for example. As schematically illustrated, the robot 900 includes a mop media holder (e.g., cleaning pad holder) 962 and a mop media (e.g., cleaning pad or web) 964 affixed to the holder 962.

The robot 900 further includes a mop media supply compartment 984, an onboard supply 964A of additional mop medias 964 (disposed in the compartment 984), a mop media removal or ejector system 966, and a mop media loading system 967. In use, the mop media ejector system 966 automatically and programmatically removes the mop media 964 from the holder 962 and discards the removed mop media 964. The mop media loading system 967 then automatically and programmatically mounts a new mop media 964 from the supply 964A on the holder 962.

The robot 900 can then execute a mopping operation with the new, clean mop media 964 affixed to the holder 962.

In some embodiments, the onboard supply 964A and the mop media loading system 967 may be omitted. In such case, the robot 900 may be used with a mop media loading dock such as the dock 880 to reload a new mop media on the holder 962.

In some embodiments, the mop media removal or ejector system 966 may be omitted. In such case, the robot 900 may be used with a mop media removal dock such as the dock 780 to remove and discard the used mop media from the holder 962.

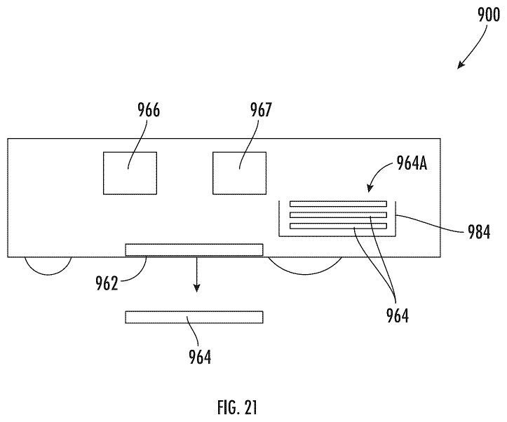

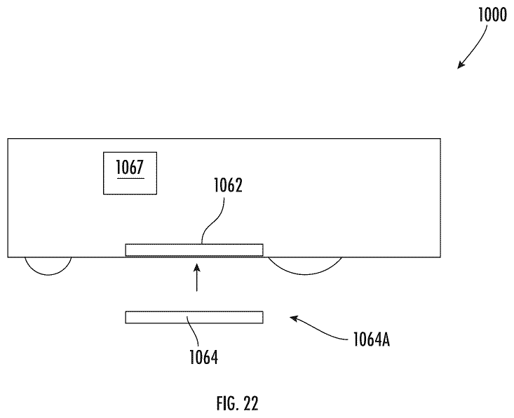

With reference to FIG. 22, a mobile cleaning robot 1000 according to further embodiments is shown therein. The mobile cleaning robot 1000 may include a vacuum system and a mopping system as described herein, for example.

As schematically illustrated, the robot 1000 includes a mop media holder (e.g., cleaning pad holder) 1062 and a mop media (e.g., cleaning pad or web) 1064 affixed to the holder 1062.

The robot 1000 further includes a mop media loading system 1067. In use, the mop media loading system 1067 automatically and programmatically mounts a mop media 1064 from an external supply 1064A on the holder 1062. The external supply 1064A may be a mop media 1064 that is resting on the ground or a dock, for example.

Robots as disclosed herein can be configured to any suitable type of mopping. The robots can execute dry mopping using a dry or nonwetted mop media. The robots can execute wet cleaning or wet mopping using a pre-wet mop media or by dispensing a cleaning fluid. The robot may spray cleaning fluid onto the surface in front of the robot as the robot traverses the surface and then absorb the applied cleaning fluid onto the mop media without slowing or evading the fluid.

The robot may spray cleaning fluid onto the surface, leave the cleaning fluid to soak, and then return to the sprayed area to absorb the applied cleaning fluid onto the mop media. The robot may delay its return to the sprayed area in order to provide a sufficient dwell time for the cleaning fluid.

The cleaning fluid discussed herein may be any suitable cleaning fluid. The cleaning fluid may be a liquid cleaning fluid. Suitable cleaning fluids may include water (with or without a soap in solution) or other solvents.

Robots as disclosed herein can be configured to any suitable sequence of vacuuming and mopping operations. The vacuuming and mopping operations and sequence thereof may be manually controlled by an operator or may be automatically and programmatically controlled by the robot controller or another controller of the robot system.

In some embodiments, the robot will vacuum a surface to remove dirt and debris, and thereafter mop the surface. This order of steps can slow contamination of the mop media.

In some embodiments, the robot will vacuum a surface to remove dirt and debris, thereafter mop the surface, and thereafter vacuum the surface again.

In some embodiments, the robot will vacuum and mop a surface substantially simultaneously.

While pump driven cleaning fluid supply mechanisms have been described above, other mechanisms may be employed. For example, the cleaning fluid may be dispensed onto the mop media or the surface to be cleaned using gravity feed or capillary action.

In some implementations, a removable mop module as disclosed herein is configured to change an attitude of the mobile cleaning robot with respect to the support surface when installed on the robot. In particular, the mop module may be configured to unweight or lift the extractors off of the surface in order to reduce drag as the robot traverses the surface. The mop module may accomplish this by changing the weight balance of the robot and/or using floor bearing features, for example.

Although some of the mop systems disclosed herein are shown and described as permanently integrated into the robot or not requiring that the mop system replace another functional component, in other embodiments, the systems or components and features thereof can be embodied in a mop module that is swappable with another functional component (e.g., a vacuum module, extractor, or cleaning head) as described for the mobile cleaning robot systems 101, 201 for example. Similarly, systems or components and features thereof of the mop modules can be permanently integrated into the hybrid robots.

The robots described herein can be controlled, at least in part, using one or more computer program products, e.g., one or more computer programs tangibly embodied in one or more information carriers, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment.

Operations associated with controlling the robots described herein can be performed by one or more programmable processors executing one or more computer programs to perform the functions described herein. Control over all or part of the robots and evacuation stations described herein can be implemented using special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass PCBs for storing data, e.g., magnetic, magneto-optical disks, or optical disks. Machine-readable storage media suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

In some embodiments, the robot 100 uses a variety of behavioral modes to effectively vacuum a working area. Behavioral modes are layers of control systems that can be operated in parallel. The robot controller 198 (e.g., microprocessor) is operative to execute a prioritized arbitration scheme to identify and implement one or more dominant behavioral modes for any given scenario, based upon inputs from the sensor system. The robot controller 198 may also be operative to coordinate avoidance, homing, and docking maneuvers with a dock.

Generally, the behavioral modes for the described robot 100 can be characterized as: (1) coverage behavioral modes; (2) escape behavioral modes, and (3) safety behavioral modes. Coverage behavioral modes are primarily designed to allow the robot 100 to perform its operations in an efficient and effective manner, while the escape and safety behavioral modes are priority behavioral modes implemented when a signal from the guidance system indicates that normal operation of the robot 100 is impaired (e.g., obstacle encountered), or is likely to be impaired (e.g., drop-off detected).

Representative and illustrative coverage behavioral modes (for vacuuming) for the robot 100 include: (1) a Spot Coverage pattern; (2) an Obstacle-Following (or Edge-Cleaning) Coverage pattern, and (3) a Room Coverage pattern. The Spot Coverage pattern causes the robot 100 to clean a limited area within the defined working area, e.g., a high-traffic area. In a certain embodiments the Spot Coverage pattern is implemented by means of a spiral algorithm (but other types of self-bounded area algorithms, such as polygonal, can be used). The spiral algorithm, which causes outward or inward spiraling movement of the robot 100, is implemented by control signals from the microprocessor to the motive system to change the turn radius/radii thereof as a function of time or distance traveled (thereby increasing/decreasing the spiral movement pattern of the robot 100).

The foregoing description of typical behavioral modes for the robot 100 are intended to be representative of the types of operating modes that can be implemented by the robot 100. One skilled in the art will appreciate that the behavioral modes described above can be implemented in other combinations and other modes can be defined to achieve a desired result in a particular application.

A navigational control system may be used advantageously in combination with the robot 100 to enhance the cleaning efficiency thereof, by adding a deterministic component (in the form of a control signal that controls the movement of the robot 100) to the motion algorithms, including random motion, autonomously implemented by the robot 100. The navigational control system operates under the direction of a navigation control algorithm. The navigation control algorithm includes a definition of a predetermined triggering event.

Broadly described, the navigational control system, under the direction of the navigation control algorithm, monitors the movement activity of the robot 100. In one embodiment, the monitored movement activity is defined in terms of the “position history” of the robot 100, as described in further detail below. In another embodiment, the monitored movement activity is defined in terms of the “instantaneous position” of the robot 100.

The predetermined triggering event is a specific occurrence or condition in the movement activity of the robot 100. Upon the realization of the predetermined triggering event, the navigational control system operates to generate and communicate a control signal to the robot 100. In response to the control signal, the robot 100 operates to implement or execute a conduct prescribed by the control signal, i.e., the prescribed conduct. This prescribed conduct represents a deterministic component of the movement activity of the robot 100.

Navigation of mobile cleaning robots 100 including both vacuum systems and mopping systems as described herein may present challenges in terms of operational efficacy and customer satisfaction, for example, in order to meet cleaning performance requirements without damage to the operating environment (e.g., mopping a carpeted surface). As such, some embodiments may further include operations performed by a robot controller (e.g., the controller 198) based on inputs from one or more sensors, one or more internally-or externally-stored databases (such as persistent map data stored in a memory), and/or one or more user inputs via a user interface (such as from a remote computing device or application installed thereon) to classify floor types in respective areas of the operating environment, and modify the behavior of the robot 100 accordingly.

In particular, as shown in FIG. 23, a controller circuit 1198 (depicted schematically) is carried within the support structure 102. In some examples, the controller 1198 includes a printed circuit board (PCB that carries a number of electronic components and computing components (for example, computer memory and computer processing chips, input/output components, etc.). In some embodiments, the controller 1198 includes a distributed network of microcontrollers, each microcontroller configured to govern a respective subsystem of the robot 100. The controller 1198 is designed, programmed, and/or otherwise configured to control operations of various other components of the robot 100 (e.g., the rollers, the side brush, and/or the drive wheels).

The controller 1198 implements the behavior-based-robotics scheme in response to feedback received from a plurality of sensors distributed about the robot 100 and communicatively coupled to the controller 1198, persistent map data, and/or user input. For instance, an array of proximity sensors 1131 are installed along the periphery of the robot 100, including the front end bumper. The proximity sensors 1131 are responsive to the presence of potential obstacles that may appear in front of or beside the robot 100 as the robot moves in the forward drive direction, and may include a bumper-mounted height sensor to detect flooring discontinuities, such as a transition in flooring type from hard floor to carpet, based on the increased height of the carpet relative to the hard floor. The robot 100 can further include an inertial measurement unit (IMU) 1165, tactile sensors 1162, cliff sensors 1132, visual sensors 1134 (such as a digital camera having a field of view optical axis oriented in the forward drive direction of the robot) for detecting features and landmarks in the operating environment and building a virtual map, for example, using VSLAM technology.

Still referring to FIG. 23, the controller 1198 is communicatively coupled to various subsystems of the robot 100, including a communications system 1205, a cleaning system 1210, a drive system 1215, a navigation sensor system 1220, a persistent map database 1199, and a user interface 1197. The controller 1198 includes a memory unit 1222 that stores data and instructions for processing by a processor 1224. The processor 1224 receives program instructions and feedback data from the memory unit 1222, executes logical operations called for by the program instructions, and generates command signals for operating the respective subsystem components of the robot 100. An input/output unit 1226 transmits the command signals and receives feedback and/or other data from various components. In this example, the communications system 1205 includes a beacon communications module 1136 and a wireless communications module 1137. The persistent map database 1199 may represent computer readable storage medium that is an internal to the robot 100 and accessible via the I/O module 1226, and/or external to the robot 100 and accessible via the wireless communication module 1137 (such as a cloud-based storage database). The user interface 1197 may likewise represent hardware that is part of the robot 100, and/or an application executing on a remote computing device (e.g., a mobile phone or other mobile device).

The cleaning system 1210 includes any of the vacuum systems 130, 230, 330, 430 and/or mopping systems 160, 260, 360, 460 described herein. The vacuum system includes multiple motor sensors 1157 that monitor operation of the roller motor 1133, the side brush motor 1154, and/or the suction fan motor 1156 to facilitate control of the vacuum system by the controller 1198. The mopping system includes sensors and systems 1361 and 1374 that monitor the media supply and the fluid supply, respectively, and motor sensors that monitor operation of the deployment motor 1363 and the agitation motor 1176A for the mop media 1164 to facilitate control of the mopping system by the controller 1198. The drive system 1215 includes a right drive-wheel motor 1158 and a left drive-wheel motor 1160 for operating the respective drive wheels in response to drive commands or control signals from the controller 1198, as well as multiple drive motor sensors 1161 to facilitate control of the drive wheels (e.g., via a suitable PWM technique).

As shown in FIG. 23, the controller 1198 generates and transmits control signals to the drive system 1215 in response to signals received from the navigation sensor system 1220 and/or the communication system 1205 to automatically select the operational state and/or control navigation of the robot 100 in the operating environment. In particular, in a robot 100 including dual vacuuming and mopping functionality, the controller 1198 is configured to classify or distinguish flooring types of areas of the operating environment, and is configured to modify the robot's operational state (e.g., to select between vacuuming and mopping modes), navigation (e.g., to traverse or avoid carpeted areas), and/or other behavior (e.g., to select cleaning patterns or cleaning order) based on the identification of the flooring types. The flooring types may be identified by the robot 100 during navigation of the surface based on inputs from one or more sensors thereof (for example, based on images captured by the visual sensor 1134), based on persistent map data stored in the database 1199 (including information collected by prior navigation of the operating environment by the robot 100 and/or other sources), and/or based on receiving identification of the floor types from a user device via the user interface 1197. The type of cleaning operation (for example, wet or dry cleaning) and/or pattern of cleaning to be performed by the robot 100 may thus be determined responsive to detection or identification of the flooring types, that is, to provide area-specific cleaning based on area classification.

In some embodiments, the controller 1198 is configured to determine the flooring type as a function of a signal from a motion sensor indicative of a change in pitch caused by the robot crossing a flooring discontinuity, and/or based on a power draw signal corresponding to the cleaning head assembly of the robot. Such examples are described in greater detail in U.S. Pat. No. 9,993,129 to Santini, the disclosure of which is incorporated by reference herein. For example, the controller 1198 may receive a signal from the IMU 1165 (for example, a six-axis IMU including a gyroscope) indicating a change in pitch to determine whether the robot 100 has traversed a floor surface threshold, or floor type interface such as a raised doorway threshold or the interface between hardwood flooring and an area rug. Additionally or alternatively, the controller 1198 may receive a signal indicative of the power draw of the roller motor 1133, where a higher power draw is indicative of a higher friction surface interaction (such as a carpeted surface), and a lower power draw is indicative of a low friction surface interaction (such as a non-carpeted surface). The controller 1198 may generate and transmit commands to the mopping system deployment actuator 1363 to retract the mop media 1164 and/or to the drive system 1215 to alter a route if the received signal(s) exceed respective thresholds that indicate the presence of a carpeted surface.

In some embodiments, the controller 1198 is configured to determine the flooring type based on an estimate of drift, as detected from sensor outputs indicating actuation characteristics, motion characteristics, and/or visual observations. Such examples are described in greater detail in U.S. Pat. No. 9,427,875 to Goel et al., the disclosure of which is incorporated by reference herein. For example, the sensor system 1220 can include odometry sensors for sensing wheel rotations of the actuator system, gyroscopic sensors for sensing angular rotation or motion of the body, and image sensors for generating visual observations of motion. The controller 1198 can estimate drift based on the actuation characteristics, motion characteristics, and/or visual observations to determine whether a surface is carpeted or non-carpeted, and may generate and transmit commands to the mopping system deployment actuator 1363 to retract the mop media 1164 and/or to the drive system 1215 to alter a route if the estimated drift indicates the presence of a carpeted surface.

In some embodiments, the controller 1198 is configured to identify a flooring type based on building, storing, and updating maps indicating locations in the operating environment (also referred to herein as persistent map data). Such examples are described in greater detail in U.S. Pat. No. 9,914,217 to Dooley et al. and U.S. Patent Application Publication No. 2018/0074508 to Kleiner et al., the disclosures of which is incorporated by reference herein. For example, the controller 1198 may build maps including a layout and location of rooms within the operating environment based on the information detected by the one or more sensors of the sensor system 1220, and may store the maps, layout, and locations of rooms in the database 1199. The controller 1198 may access the database 1199 to determine whether a location in the operating environment is carpeted or non-carpeted, and may issue a command to generate and transmit commands to the mopping system deployment actuator 1363 to retract the mop media 1164 and/or to the drive system 1215 to alter a route if the persistent map data indicates the presence of a carpeted surface.

In some embodiments, the controller 1198 is configured to receive a user indication or identification of the flooring types in the environment via the user interface 1197. FIG. 24 is a graphical representation of a map view 2402 that may be displayed via a user interface 1197 illustrating detection and/or user selection of floor types for area-specific cleaning operations according to some embodiments of the present invention. The map view 2402 may be generated based on the persistent map data stored in the database 1199. As shown in FIG. 24, the graphical representation 2402 may indicate flooring types including hard floor 2404 and carpet 2406. Using the map 2402 of the environment displayed on the user interface 1197, a user may draw or otherwise define a boundary 2405 around a rug displayed on the map to indicate that it corresponds to a carpeted area 2406 and/or other keep-out zone with respect to the mopping functionality. User-indicated flooring types 2405 may also be aligned or otherwise determined to correspond with the flooring types detected by the robot 100 based on sensor inputs and/or machine learning. For example, the robot 100 may detect edges of the carpeted area 2406 on a hard floor area 2404 based on signals from one or more sensors of the sensor system 1220. As the user-defined boundary 2405 may not exactly correspond to the actual boundaries of the rug detected by the robot sensor(s), the controller 1198 may operate the robot 100 to navigate with a set-back area relative to the boundary 2405 or detected carpet area 2406 to provide a margin of error. For example, in performing a mopping operation, the controller 1198 may calculate a margin that is sufficient to allow for some dispersion of cleaning fluid that may be present on the mop media 1164 based on the detected boundaries of the carpeted area 2406 and may operate the robot 100 to navigate with a margin around the carpeted area 2406.

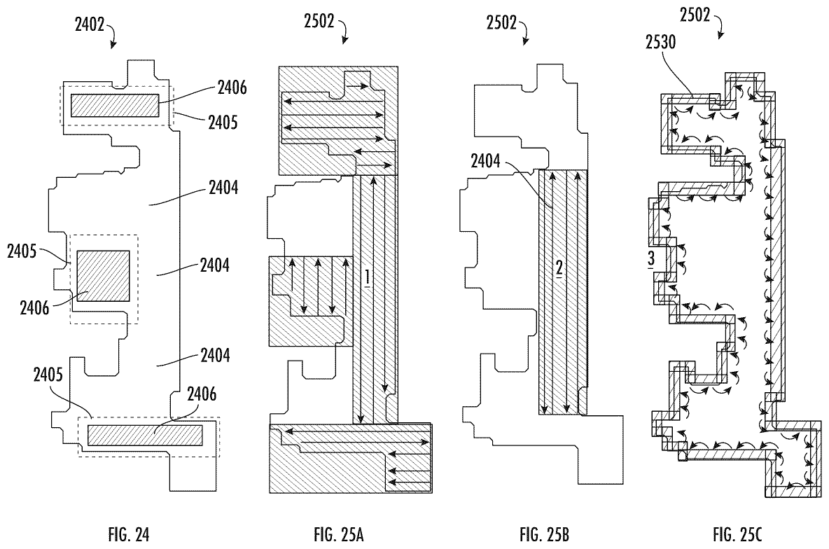

In some embodiments, the controller 1198 may be configured to compute path planning and strategy for cleaning differently-classified areas of the surface of the operating environment (including the order of cleaning of one or more locations), generally referred to herein as a coverage pattern, based on input from the sensors of the robot 100, the persistent map database 1199, and/or the user interface 1197. Such examples are described in greater detail in U.S. Patent Application Publication No. 2018/0074508 to Kleiner et al., the disclosure of which is incorporated by reference herein. The computed coverage pattern may define an improved or optimized cleaning strategy that treats areas differently with respect to their recognized context or classification, for instance, by indicating sequential cleaning of locations or sub-regions of a surface based on their respective classifications. For example, it may be advantageous to perform vacuuming operations to remove debris from a flooring surface prior to mopping operations, in order to avoid damaging the flooring surface by trapping and dragging debris across the surface with the mop media. As such, as shown in the map view 2502 of FIGS. 25A-25C, the controller 1198 may compute the coverage pattern so as to first execute vacuuming of both the hard floor areas 2404 and carpeted areas 2406 (in FIG. 25A), then execute mopping of the hard floor area 2404 while avoiding the carpeted areas 2406 (in FIG. 25B), and then execute vacuuming of the perimeter area 2530 (in FIG. 25C). The order of cleaning and/or cleaning patterns may also be confirmed (or overridden) by user input received via the user interface 1197.

It will be understood that the coverage pattern may be determined and/or modified after initial detection of the flooring types, as learning and building of the map of the operating environment may require that at least one navigation or cleaning operation has been performed. That is, in computing the coverage patterns as described herein, floor type identification may be based on at least one prior navigation of the operating environment, using persistent map data. For example, the robot 100 may first vacuum the entire surface of the operating environment as shown in FIG. 25A. During this initial navigation, the robot 100 may store map data in the database 1199, such that areas may be identified as hard floor areas 2404 and carpeted areas 2406. After completing the vacuum operation in FIG. 25A, the robot 100 may perform the mopping operations in FIG. 25B by traversing only the hard floor areas 2404, as identified based on data collected during the initial navigation. Cleaning performance may be further improved by using persistent mapping in combination with user labeling of areas and/or context-sensitive behaviors. For example, the coverage pattern may specify cleaning of the hard floor areas 2404 more efficiently in a ranking pattern (as shown in FIG. 25B), and cleaning the perimeter area 2530 in an edge cleaning pattern (as shown in FIG. 25C). These example cleaning behaviors in response to the determined coverage pattern can be observed and distinguished.

In embodiments where a robot 100 includes swappable vacuuming and mopping modules 130 and 160, the controller 198 is configured to detect a currently-installed cleaning module or currently-deployed cleaning mechanism (such as the vacuum module 130 or the mop module 160) based on inputs from one or more sensors (such as the presence sensor 1178), and is configured to modify the cleaning pattern or other behavior of the robot 100 based on the currently-installed module as well as the detected flooring types. For example, responsive to receiving a signal from the presence sensor 1178 indicating that the mop module 160 is currently installed, the controller 1198 can operate the drive system 1215 to confine the navigation of the robot 100 to areas of the operating environment that have been identified as non-carpeted areas, for example, using or in conjunction with any of the floor-type detection operations described herein.

The operational state and/or cleaning pattern of the robot 100 may thus be surface dependent, location dependent, and/or dependent on user selection, for example, based on sensor signals from one or more sensors of the sensor system 1220, persistent map data from the persistent map database 1199, and/or user input from the user interface 1197.

### NOTES AND EXAMPLES

The following, non-limiting examples, detail certain aspects of the present subject matter to solve the challenges and provide the benefits discussed herein, among others.

Example 1 is a mobile cleaning robot system comprising: a mobile cleaning robot comprising: a support structure defining an extractor cavity; and a drive system connected to the support structure and configured to move the mobile cleaning robot; a vacuum module including an extractor removably installable in the extractor cavity, the vacuum module configured to vacuum a surface when the vacuum module is installed in the extractor cavity; and a mop module including a cleaning pad, the mop module removably installable in the extractor cavity, the robot configured to mop the surface when the mop module is installed in the extractor cavity.

In Example 2, the subject matter of Example 1 includes, wherein: the mop module comprises a cleaning fluid supply system comprising an applicator configured to dispense a cleaning fluid on the surface.

In Example 3, the subject matter of Example 2 includes, wherein: the cleaning fluid supply system comprises a pump to deliver the cleaning fluid to the applicator.

In Example 4, the subject matter of Example 3 includes, wherein: the cleaning fluid supply system comprises a reservoir connected to the pump and configured to contain a supply of the cleaning fluid.

In Example 5, the subject matter of Examples 3-4 includes, an extractor drive gear of the mobile cleaning robot is configured to drive the pump to deliver the cleaning fluid to the applicator.

In Example 6, the subject matter of Examples 2-5 includes, wherein: the mop module comprises a mop housing mountable within the extractor cavity, the mop housing including a pad holder, the cleaning pad secured to the mop housing by the pad holder.

In Example 7, the subject matter of Example 6 includes, wherein: the cleaning fluid supply system comprises nozzle connected to the mop housing and directed forward of the cleaning pad when the mop module is located in the extractor cavity.

In Example 8, the subject matter of Examples 1-7 includes, an agitation system operable to move the cleaning pad relative to the mobile cleaning robot to scrub the surface with the cleaning pad.

In Example 9, the subject matter of Example 8 includes, an extractor drive gear of the mobile cleaning robot is configured to drive the agitation system.

In Example 10, the subject matter of Example 9 includes, wherein: the mop module comprises a drive shaft that engages the extractor drive gear.

Example 11 is a mobile cleaning robot comprising: a drive system operable to move the mobile cleaning robot along a surface; an integral vacuum system configured to vacuum the surface; and an integral mop system configured to mop the surface, the mop system comprising: a cleaning pad holder connected to an external surface of the mobile cleaning robot and configured to hold a cleaning pad in contact with the surface at a location that is outboard from the external surface.

In Example 12, the subject matter of Example 11 includes, wherein: the cleaning pad holder is removably mounted to the mobile cleaning robot.

In Example 13, the subject matter of Examples 11-12 includes, wherein the cleaning pad holder is selectively positionable in each of: a stored position, in which the cleaning pad is held out of contact with the surface by the cleaning pad holder; and a deployed position, in which the cleaning pad is held in contact with the surface by the cleaning pad holder.

In Example 14, the subject matter of Example 13 includes, wherein: the cleaning pad holder includes a hinge configured to enable an operator to pivot the cleaning pad into the stored position or retracted position.

In Example 15, the subject matter of Examples 13-14 includes, an actuator connected to the cleaning pad holder to pivot the cleaning pad holder between the stored position and the deployed position.

In Example 16, the subject matter of Examples 13-15 includes, an actuator connected to the cleaning pad holder to translate the cleaning pad holder between the stored position and the deployed position.

In Example 17, the subject matter of Examples 15-16 includes, a controller configured to receive a user indication of flooring type in an environment via a user interface and configured to detect a flooring type in the environment based on output from one or more sensors of the mobile cleaning robot.

In Example 18, the subject matter of Example 17 includes, wherein: the controller is configured to operate the actuator to move the cleaning pad holder between the stored position and the deployed position based on the user indication flooring type or the detected flooring type.

In Example 19, the subject matter of Example 18 includes, wherein: the controller is configured to correlate the user indication flooring types with the detected flooring type based on the output from the one or more sensors to produce a correlated flooring type.

In Example 20, the subject matter of Example 19 includes, wherein: the controller is configured to operate the actuator to move the cleaning pad holder to the stored position when the mobile robot approaches a correlated flooring type of a carpet, and is configured to move the cleaning pad holder to the deployed position when mobile robot encounters a correlated flooring type of a hard floor.

Example 21 is a mobile cleaning robot comprising: a drive system operative to move the mobile cleaning robot; an integral vacuum system configured to vacuum a surface; and an integral mop system configured to mop the surface, the mop system including a mop media positioned to contact the surface.

In Example 22, the subject matter of Example 21 includes, wherein the mop system includes a cleaning fluid supply system including: a reservoir to contain a supply of a cleaning fluid; and a pump to dispense the cleaning fluid on the surface.

In Example 23, the subject matter of Examples 21-22 includes, wherein the mop system includes an agitation system configured to forcibly move the mop pad relative to the support structure to create a scrubbing action between the mop media and the surface.

Example 24 is a mobile cleaning robot system comprising: a mobile cleaning robot including: a support structure; and a drive system operative to move the mobile cleaning robot; a vacuum module configured to be removably mounted on the support structure, wherein the robot is configured to vacuum a surface when the vacuum module is installed therein; and a mop module configured to be removably mounted on the support structure, wherein the robot is configured to mop the surface when the mop module is installed therein, the mop module including: a mop media positioned to contact the surface; and a cleaning fluid supply system including: a reservoir to contain a supply of a cleaning fluid; and a pump to dispense the cleaning fluid on the surface.

Example 25 is a mop module for use with a mobile cleaning robot, the mobile cleaning robot including a support structure and a drive system operative to move the mobile cleaning robot, the mop module comprising: a mop media positioned to contact a surface; and a cleaning fluid supply system including: a reservoir to contain a supply of a cleaning fluid; and a pump to dispense the cleaning fluid on the surface; wherein the mop module is configured to be removably mounted on the support structure, and the robot is configured to mop the surface when the mop module is installed therein.

Example 26 is a mobile cleaning robot system comprising: a mobile cleaning robot including: a support structure; and a drive system operative to move the mobile cleaning robot; a vacuum module configured to be removably mounted on the support structure, wherein the robot is configured to vacuum a surface when the vacuum module is installed therein; and a mop module configured to be removably mounted on the support structure, wherein the robot is configured to mop the surface when the mop module is installed therein, the mop module including: a mop media positioned to contact the surface; and an agitation system configured to forcibly move the mop pad relative to the support structure to create a scrubbing action between the mop media and the surface.

Example 27 is a mop module for use with a mobile cleaning robot, the mobile cleaning robot including a support structure and a drive system operative to move the mobile cleaning robot, the mop module comprising: a mop media positioned to contact a surface; and an agitation system configured to forcibly move the mop pad relative to the support structure to create a scrubbing action between the mop media and the surface; wherein the mop module is configured to be removably mounted on the support structure, and the robot is configured to mop the surface when the mop module is installed therein.

Example 28 is a mobile cleaning robot system comprising: a mobile cleaning robot including: a support structure including an extractor cavity; and a drive system operative to move the mobile cleaning robot; an vacuum system configured to vacuum a surface, the vacuum system including an extractor configured to be removably mounted in the extractor cavity; and a mop module including a mop media; wherein the mop module is configured to be removably mounted on the support structure in the extractor cavity in place of the extractor; and wherein the robot is configured to mop the surface when the mop module is installed in the extractor cavity.

In Example 29, the subject matter of Example 28 includes, wherein the mop module includes a cleaning fluid supply system including: a reservoir to contain a supply of a cleaning fluid; and a pump to dispense the cleaning fluid on the surface.

In Example 30, the subject matter of Example 29 includes, configured to drive the pump via an extractor drive gear of the mobile cleaning robot.

In Example 31, the subject matter of Examples 29-30 includes, an agitation system configured to forcibly move the mop pad relative to the mobile cleaning robot to create a scrubbing action between the mop media and the surface.

In Example 32, the subject matter of Example 31 includes, configured to drive the agitation system via an extractor drive gear of the mobile cleaning robot.

Example 33 is a mobile cleaning robot comprising: a drive system operative to move the mobile cleaning robot; and a mop system configured to mop a surface, the mop system including: a mop media positioned to contact the surface; and an onboard mop media supply system configured to replace the mop media with a new mop media.

In Example 34, the subject matter of Example 33 includes, wherein the mop media supply system includes a supply roll holding a web of the clean mop media and a mechanism operable to pull new sections of the web into contact with the surface.

In Example 35, the subject matter of Example 34 includes, a deployment actuator operable to selectively push the web into contact with the surface.

In Example 36, the subject matter of Examples 33-35 includes, wherein the mop media supply system includes: a compartment on the mobile cleaning robot containing a replacement mop media pad; and a mechanism operable to replace the mop media with the replacement mop media pad.

In Example 37, the subject matter of Example 36 includes, an onboard ejector system operable to eject the used mop media from the robot.

In Example 38, the subject matter of Examples 33-37 includes, a vacuum system configured to vacuum the surface.

Example 39 is a mobile cleaning robot comprising: a drive system operative to move the mobile cleaning robot; and a mop system configured to mop a surface, the mop system including: a mop media positioned to contact the surface; and an onboard ejector system operable to eject the mop media from the robot.

Example 40 is a mobile cleaning robot comprising: a drive system operative to move the mobile cleaning robot; and a mop system configured to mop a surface, the mop system including: a mop media holder configured to hold a mop media in contact with the surface; and an onboard mop media loading system operable to mounts a mop media from an external supply on the mop media holder.

In Example 41, the subject matter of Example 40 includes, a vacuum system configured to vacuum the surface.

Example 42 is a mobile cleaning robot comprising: a robot body; a drive system operative to move the mobile cleaning robot; an integral vacuum system configured to vacuum a surface; an integral mop system configured to mop the surface, the mop system including: a mop media; and a mop media holder configured to hold the mop media in contact with the surface laterally outboard from the robot body.

In Example 43, the subject matter of Example 42 includes, wherein the mop media holder is removably and replaceably mounted on the robot body.

In Example 44, the subject matter of Examples 42-43 includes, wherein the mop media holder is selectively positionable in each of: a stored position, wherein the mop media is held out of contact with the surface; and a deployed position, wherein the mop media is held in contact with the surface.

In Example 45, the subject matter of Examples 42-44 includes, a mechanism to pivot the mop media holder between the stored position and the deployed position.

In Example 46, the subject matter of Examples 42-45 includes, a mechanism to translate the mop media holder between the stored position and the deployed position.

Example 47 is a mobile cleaning robot system comprising: a mobile cleaning robot including a drive system operative to move the mobile cleaning robot; a mop system configured to mop the surface, the mop system including: a mop media holder; and a mop media mounted on the mop media holder and positioned to contact the surface; and a dock including a mop media removal system operable to remove the mop media from the mop media holder.

In Example 48, the subject matter of Example 47 includes, wherein the mobile cleaning robot includes a vacuum system configured to vacuum the surface.

Example 49 is a mobile cleaning robot system comprising: a mobile cleaning robot including: a drive system operative to move the mobile cleaning robot; a mop system configured to mop the surface, the mop system including a mop media holder configured to hold a mop media in contact with the surface; and a dock including a mop media loading system operable to mount the mop media on the mop media holder.

In Example 50, the subject matter of Example 49 includes, wherein the mobile cleaning robot includes a vacuum system configured to vacuum the surface.

In Example 51, the subject matter of Examples 49-50 includes, wherein:
the vacuum system includes a debris chamber; and the dock further includes a debris evacuation system operable to remove debris from the debris chamber.

In Example 52, the subject matter of Examples 21-51 includes, at least one processor; and a memory coupled to the processor, the memory comprising a non-transitory computer-readable storage medium storing computer-readable program code therein that is executable by the processor to perform operations comprising: identifying one or more flooring types of the surface; and modifying an operational state of the mobile cleaning robot based on the one or more flooring types, the operational state comprising a vacuum mode in which the vacuum system is deployed to vacuum the surface or a mopping mode in which the mop system is deployed to mop the surface.

Example 53 is a method of operating a mobile cleaning robot, the method comprising: executing, by at least one processor, computer readable instructions stored in a non-transitory computer readable storage medium to perform operations comprising: identifying one or more flooring types of a surface of an operating environment of the mobile cleaning robot; and modifying an operational state of the mobile cleaning robot based on the one or more flooring types, the operational state comprising a vacuum mode in which the mobile cleaning robot is configured to vacuum the surface or a mopping mode in which the mobile cleaning robot is configured to mop the surface.

In Example 54, the subject matter of Examples 24-53 includes, wherein the mobile cleaning robot further comprises: at least one processor; and a memory coupled to the processor, the memory comprising a non-transitory computer-readable storage medium storing computer-readable program code therein that is executable by the processor to perform operations comprising: detecting an operational state of the mobile cleaning robot, the operational state comprising a vacuum mode in which the mobile cleaning robot is configured with the vacuum module or a mopping mode in which the mobile cleaning robot is configured with the mop module; identifying one or more flooring types of the surface; and modifying a behavior of the mobile cleaning robot based on the operational state that was determined and the one or more flooring types that were identified.

Example 55 is a method of operating a mobile cleaning robot, the method comprising: executing, by at least one processor, computer readable instructions stored in a non-transitory computer readable storage medium to perform operations comprising: detecting an operational state of the mobile cleaning robot, the operational state comprising a vacuum mode in which the mobile cleaning robot is configured to vacuum a surface or a mopping mode in which the mobile cleaning robot is configured to mop the surface; identifying one or more flooring types of the surface; and modifying a behavior of the mobile cleaning robot based on the operational state that was determined and the one or more flooring types that were identified.

Example 56 is at least one machine-readable medium including instructions that, when executed by processing circuitry, cause the processing circuitry to perform operations to implement of any of Examples 1-55.

Example 57 is an apparatus comprising means to implement of any of Examples 1-55.

Example 58 is a system to implement of any of Examples 1-55.

Example 59 is a method to implement of any of Examples 1-55.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. (canceled)

2. A mobile cleaning robot system configured to clean a flooring surface of an environment, the mobile cleaning robot system comprising:
a mobile cleaning robot comprising:
a body including a cavity; and
a drive system connected to the body and operable to move the mobile cleaning robot about the environment;
a vacuum module including an extractor operable to extract debris from the environment when the vacuum module is installed in the cavity, the vacuum module user-securable to the cavity of the body; and
a mop module including a cleaning pad configured to mop the flooring surface when the mop module is installed in the cavity, the mop module user-securable to the cavity of the body.

3. The mobile cleaning robot system of claim 2, wherein the mop module includes a fluid supply system including an applicator configured to dispense a cleaning fluid on the flooring surface.

4. The mobile cleaning robot system of claim 3, wherein the fluid supply system includes:
a reservoir configured to contain a supply of the cleaning fluid; and
a pump to deliver the cleaning fluid from the reservoir to one or more of the cleaning pad and the flooring surface.

5. The mobile cleaning robot system of claim 4, wherein the fluid supply system includes a shaft connectable to a drive gear of the mobile cleaning robot when the mop module is installed in the cavity, the shaft configured to be driven by the drive gear to operate the pump.

6. The mobile cleaning robot system of claim 4, wherein the mop module includes an agitation system operable to forcibly move the cleaning pad relative to the mobile cleaning robot to scrub the flooring surface with the cleaning pad.

7. The mobile cleaning robot system of claim 2, wherein the body includes a seating located between a front portion of the mobile cleaning robot and a rear portion of the mobile cleaning robot, the seating configured to receive the mop module to allow the mobile cleaning robot to perform mopping operations when the vacuum module is not installed and to receive the vacuum module to allow the mobile cleaning robot to perform vacuuming operations when the mop module is not installed.

8. The mobile cleaning robot system of claim 7, wherein the mobile cleaning robot includes:
a lid connected to a top portion of the body, the lid movable between a closed position and an open position, the cavity user-accessible to install or remove the mop module or the vacuum module from above the mobile cleaning robot when the lid is open, and the cavity enclosed from above the mobile cleaning robot when the lid is closed.

9. The mobile cleaning robot system of claim 8, wherein the mobile cleaning robot includes:
a hinge connected to the body and the lid to allow the lid to hingeably move between the open position and the closed position.

10. The mobile cleaning robot system of claim 8, wherein the mobile cleaning robot includes:
a module sensor connected to one or more of the lid and the body configured to generate a signal based on one or more of a presence or absence of one or more of the mop module and the vacuum module.

11. The mobile cleaning robot system of claim 10, wherein the mobile cleaning robot includes:
a controller connected to the body and configured to determine whether the mop module and the vacuum module are installed in the cavity.

12. A mobile cleaning robot system configured to clean a flooring surface of an environment, the mobile cleaning robot system comprising:
a mobile cleaning robot comprising:
a body including a cavity; and
a drive system connected to the body and operable to move the mobile cleaning robot about the environment;
a vacuum module including an extractor operable to extract debris from the environment when the vacuum module is installed in the cavity, the vacuum module user-securable to the cavity of the body; and
a mop module including a cleaning pad configured to mop the flooring surface when the mop module is installed in the cavity, the mop module user-securable to the cavity of the body.

13. The mobile cleaning robot system of claim 12, wherein the vacuum module includes a housing and a filter user-removable from the housing.

14. The mobile cleaning robot system of claim 13, wherein the vacuum module includes a lid movable to access the filter.

15. The mobile cleaning robot system of claim 13, wherein the vacuum module includes a chamber connected to an intake port and an exhaust port, the intake port connected to a cleaning head of the mobile cleaning robot and the exhaust port connected to a blower of the mobile cleaning robot to generate an airstream through the cleaning head and through the chamber.

16. The mobile cleaning robot system of claim 15, wherein the chamber includes a first chamber and a second chamber separated by the filter, the first chamber configured to collect debris from the airstream.

17. The mobile cleaning robot system of claim 16, wherein the vacuum module includes a bottom door connected to the first chamber, the bottom door user-openable to empty debris from the first chamber.

18. The mobile cleaning robot system of claim 16, wherein the vacuum module includes an evacuation port configured to engage with a suction device of an evacuation station for evacuation of the first chamber by the evacuation station.

19. A mobile cleaning robot system configured to clean a flooring surface of an environment, the mobile cleaning robot system comprising:
a mobile cleaning robot comprising:
a body including a cavity; and
a drive system connected to the body and operable to move the mobile cleaning robot about the environment;
a vacuum module including an extractor operable to extract debris from the environment when the vacuum module is installed in the cavity, the vacuum module user-securable to the cavity of the body; and
a mop module including a cleaning pad configured to mop the flooring surface when the mop module is installed in the cavity, the mop module user-securable to the cavity of the body.

20. The mobile cleaning robot system of claim 19, wherein the vacuum module includes:
a housing and a filter user-removable from the housing;
a lid moveable to access the filter; and
a chamber connected to an intake port and an exhaust port, the intake port connected to a cleaning head of the mobile cleaning robot and the exhaust port connected to a blower of the mobile cleaning robot to generate an airstream through the cleaning head and through the chamber, the chamber including a first chamber and a second chamber separated by the filter, the first chamber configured to collect debris from the airstream.

21. The mobile cleaning robot system of claim 20, wherein the body includes:
a seating located between a front portion of the mobile cleaning robot and a rear portion of the mobile cleaning robot, the seating configured to receive the mop module to allow the mobile cleaning robot to perform mopping operations when the vacuum module is not installed and to receive the vacuum module to allow the mobile cleaning robot to perform vacuuming operations when the mop module is not installed;
a lid connected to a top portion of the body, the lid movable between a closed position and an open position, the cavity user-accessible to install or remove the mop module or the vacuum module from above the mobile cleaning robot when the lid is open, and the cavity enclosed from above the mobile cleaning robot when the lid is closed; and
a hinge connected to the body and the lid to allow the lid to hingeably move between the open position and the closed position.
